(19) United States
(12) Patent Application Publication
(10) Pub. No.: US 2004/0264513 A1
(43) Pub. Date: Dec. 30, 2004

(54) Rare-earth-doped fiber and an optical fiber laser using the same

(75) Inventors: Kensuke Shima, Sakura-shi (JP); Tetsuya Sakai, Sakura-shi (JP)

Correspondence Address: SUGHRUE MION, PLLC, 2100 Pennsylvania Avenue, N.W., Washington, DC, 20037-3213, US

(73) Assignee: FUJIKURA LTD.

(21) Appl. No.: 10/873,462

(22) Filed: Jun. 23, 2004

(30) Foreign Application Priority Data
Jun. 24, 2003 (JP) 2003-179848

(51) Int. Cl. H01S 3/30

(52) U.S. Cl. 372/6

(57) ABSTRACT

A rare-earth-doped fiber includes a center core, made of silica glass into which a rare-earth element is doped; a plurality of outer cores; an inner cladding, disposed around the center core and the outer cores; and an outer cladding, disposed around the inner cladding. The refractive index of the inner cladding is less than that of the inner and outer cores, and the refractive index of the outer cladding is less than that of the inner cladding. At least one of the center core and the outer cores is disposed in an area such that the distance between it and the center of the rare-earth-doped fiber should be greater than 0.71r, where r indicates an outer radius of the inner cladding.

The present application is based on patent application No. 2003-179848 filed in Japan Jun. 24, 2003, the content of which is incorporated herein by reference.

### BACKGROUND OF THE INVENTION

1. Field of the Invention

The present invention relates to a rare-earth-doped fiber which is used for an optical fiber laser and to an optical fiber laser using the same.

2. Discussion of Related Art

A conventional optical fiber laser is illustrated in FIG. 4.

In FIG. 4, reference numeral 101 indicates a pumping laser diode. Reference numeral 102 indicates an optical filter. Reference numeral 103 indicates a rare-earth-doped fiber. Reference numeral 104 indicates a tip section of the rare-earth-doped fiber.

In this optical fiber laser, an optical filter 102, connected to an end surface of the rare-earth-doped fiber 103, is for transmitting laser light which is emitted from a pumping laser diode 101 and for reflecting laser light which is emitted from the rare-earth-doped fiber 103. A pumping laser diode 101 is connected to the optical filter 102 for emitting light so as to be incident into the rare-earth-doped fiber 103 (see U.S. Pat. No. 6,347,100).

FIGS. 5A and 5B illustrate a tip section 104 of the rare-earth-doped fiber 103. FIG. 5A is a cross section along a center axis of the rare-earth-doped fiber 103. FIG. 5B is a cross section viewed from line A-A in FIG. 5A.

In FIGS. 5A and 5B, reference numeral 111 indicates a mirror which transmits a part of the laser light which is emitted from the rare-earth-doped fiber 103 and reflects a part of the laser light. Reference numeral 112 indicates a core of the rare-earth-doped fiber 103 into which a rare-earth-doped element is doped. Reference numeral 113 indicates an inner cladding which has a lower refractive index than the refractive index of the core 112. Reference numeral 114 indicates an outer cladding which has a lower refractive index than the refractive index of the inner cladding 113.

As shown in FIGS. 5A-5B, a conventional rare-earth-doped fiber 103 has only a single core 1 12. It is common that the diameter of the core 112 is set at several μm so as to provide single mode laser light. If a multi-mode oscillation occurs in the optical fiber laser in which the rare-earth-doped fiber 103 is used, the operability may be unstable under condition that the core 112 is a multi-mode waveguide because the diameter of the core 112 is set at several μm.

However, if the diameter of the core 112 is several μm, the volume of the core per a unit length of the rare-earth-doped fiber 103 is small. As a result, the volume of the rare-earth-doped element per unit length of the rare-earth-doped fiber 103 is also small, and a long rare-earth-doped fiber 103 is necessary in order to provide an optical fiber laser which has a higher output. Therefore, it is difficult to produce a small optical fiber laser.

Furthermore, as shown in FIG. 6, skew modes of a pumping light (laser light) which do not transmit through the core 112 in the rare-earth-doped fiber 103 and, there is a problem in that it is difficult to realize an efficient pumping operation in the rare-earth-doped element which is contained in the core 112.

### SUMMARY OF THE INVENTION

The present invention was made in consideration of the above problems. An object of the present invention is to provide a rare-earth-doped fiber, which has a superior pumping efficiency and a higher volume of rare-earth element per unit length, and an optical fiber laser using the same.

According to the present invention, a rare-earth-doped fiber comprises a plurality of cores, each made of silica glass into which rare-earth elements are doped; an inner cladding, disposed around the core, and having a refractive index lower than a refractive index of the core; and an outer cladding, disposed around the inner cladding, and having a refractive index lower than the refractive index of the inner cladding.

According to an aspect of the present invention, the silica glass, which is used for the core can be pure silica glass or silica into which Ge or Al is doped.

In the above rare-earth-doped fiber, the plurality of cores may be disposed outside a radius of 0.71 times the outer radius of the inner cladding.

The present invention also provides an optical fiber laser in which the above rare-earth doped fiber is used.

As explained above, in the present invention, the rare-earth-doped fiber comprises a plurality of cores, each made of silica glass doped with a rare earth element. Thus, it is possible to eliminate instability in the oscillation in the fiber, and the operability of the optical fiber laser can be stabilized.

Also, the total core volume of the fiber is increased and a larger volume of rare-earth element is doped per unit length. Therefore, it is possible to realize a higher output from an optical fiber laser in which a short rare-earth-doped fiber is used, and it is possible to realize a smaller device incorporating the rare-earth-doped fiber.

Additionally, because a plurality of cores doped with rare earth elements are located outside the center of the fiber, a pumped light skew mode can be used effectively, and pumping efficiency can be improved.

Furthermore, the plurality of cores are surrounded by a common inner cladding. Therefore, it is possible to pump all of the plurality of cores by introducing pumping light from a light source into the fiber at a single location. Therefore, an optical fiber laser incorporating this fiber does not require a plurality of sections at which pumping light is introduced, as is required with a conventional fiber, and it is possible to reduce both the size of the device and the manufacturing cost thereof.

### BRIEF DESCRIPTION OF THE DRAWINGS

These and other features, aspects, and advantages of the present invention will become better understood with reference to the following description, appended claims, and accompanying drawings, which should not be read to limit the invention in any way, in which:

FIG. 1 is a cross section of a rare-earth-doped fiber according to the present invention.

FIG. 2 is a cross section for showing a skew mode in a cross section of a rare-earth-doped fiber according to the present invention.

FIG. 3 is a cross section of an optical fiber laser according to the present invention.

FIG. 4 is a cross section of a conventional optical fiber laser.

FIG. 5A is a cross section along a central axis of a conventional rare-earth-doped fiber.

FIG. 5B is a cross section of the fiber of FIG. 5A viewed from the line A-A in FIG. 5A.

FIG. 6 is a cross section illustrating a skew mode in a conventional rare-earth-doped fiber.

### DETAILED DESCRIPTION OF THE INVENTION

The present invention is explained in further detail with reference to the accompanying drawings, as follows.

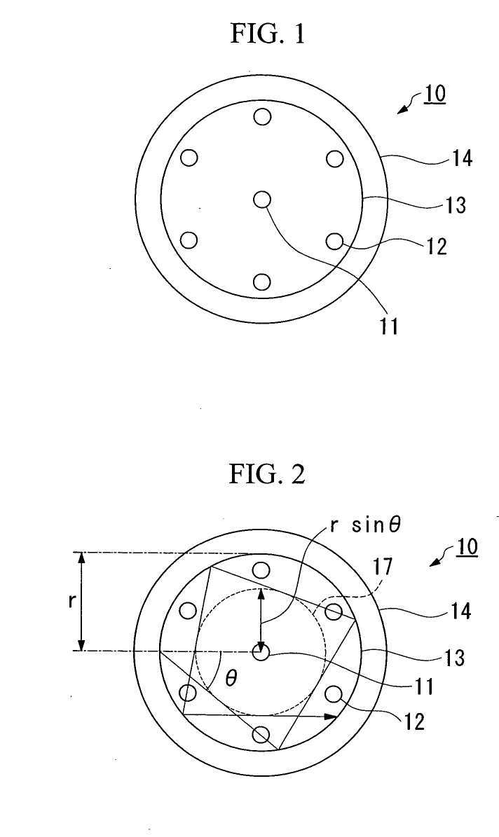

FIG. 1 is a cross section of a rare-earth-doped fiber according to the present invention.

The rare-earth-doped fiber 10 of FIG. 1 comprises a center core 11, disposed in the center of the rare-earth-doped fiber 10; six outer cores 12, disposed near a boarder of an inner cladding 13 and an outer cladding 14 with equal intervals therebetween so as to have the central axis in common with the center core 11; an inner cladding 13, disposed around the center core 11 and the outer cores 12 so as to be concentric around the center core 11; and an outer cladding 14, disposed around the inner cladding 13.

The outer diameter of the rare-earth-doped fiber 10 is between about 200 μm and 1000 μm. Within this range, the diameter of the rare-earth-doped fiber 10 may be set according to the number of cores disposed within the inner cladding 13.

The outer diameter of each of the center core 11 and the outer cores 12, measured from the center of each of the cores, is between about 2 μm and 12 μm.

The center core 11 and the outer cores 12 are formed of silica glass into which approximately 1,000 to 40,000 ppm (weight ratio) of rare-earth elements are doped. Erbium, yttrium, ytterbium, neodymium, holmium, and praseodymium can be used to dope the silica glass of the cores. Because these rare-earth-elements are doped into the center core 11 and the outer cores 12, a rare-earth ion absorbs the pumping light so as to excite the ions. Thus, it is possible to emit light which has a different wavelength from the wavelength of the pumping light.

The outer diameter of the inner cladding 13 is between about 100 82 m and 600 μm. The outer diameter of the inner cladding 13 may be set according to the number of cores which are disposed within the inner cladding 13.

The inner cladding 13 is formed of a material member which has a refractive index lower than the refractive indices of the center core 11 and the outer cores 12. Fluorine-doped silica glass may be used as the material member forming the inner cladding 13. Also, if a dopant such as a germanium, for increasing the refractive index, is doped into the center core and the outer cores, it is possible to use silica glass for the cladding.

The outer diameter of the outer cladding 14 is between about 200 μm and 800 μm. The outer diameter of the outer cladding 14 may be set according to the number of cores which are disposed within the inner cladding 13.

The outer cladding 14 is formed of a material member which has a refractive index which is lower than the refractive index of the inner cladding 13. A fluorine resin may be used as the material member forming the outer cladding 14.

According to an exemplary embodiment of the present invention, a rare-earth-doped fiber 10 comprises a center core 11 and six outer cores 12 which are disposed around the center core 11 so as to have equal intervals between the outer cores 12 and so that a central axes is common between the center core 11 and the outer cores 12. However, the rare-earth-doped fiber of the present invention is not limited to such a structure. That is, it is acceptable if a core is not disposed in a center of the fiber. In the rare-earth-doped fiber according to the present invention, it is acceptable as long as a plurality of cores are disposed randomly within the inner cladding.

Also, though FIGS. 1-2 illustrate an uncoated fiber, the present invention is not limited such a structure. It is acceptable if the rare-earth-doped fiber according to the present invention is a fiber which has a coating layer around a cladding.

In order to manufacture such a rare-earth-doped fiber, first, a plurality of through holes, parallel to the longitudinal direction of the fiber are formed at predetermined positions on a material member for the inner cladding, the material member of the inner cladding having a refractive index lower than that of the cores. Cores into which rare-earth elements are doped are inserted in these through holes. Next, the inner cladding having the cores inserted therein is drawn until a predetermined diameter is obtained. After that, the drawn inner cladding having the cores inserted therein is coated by a resin which has a refractive index lower than that of the inner cladding. Thus, a rare-earth-doped fiber is obtained.

The differences in the refractive indices of the center core, the outer cores, and the inner cladding, and the diameters of the inner core and the outer cores are all determined in order to realize single mode operation in each of the inner core and the outer cores, in a wavelength in which the rare-earth element is illuminated. It is at this wavelength that a laser comprising the fiber oscillates. By setting the refractive indices and the diameters in this way, it is possible to avoid unstable oscillation in the optical fiber laser which uses such a rare-earth-doped fiber 10, and thus, to realize a stable operation.

The rare-earth-doped fiber 10 has a plurality of cores, each formed of silica glass into which a plurality of rare-earth elements are doped. Therefore, the total volume of core material is large and the volume of the rare-earth elements is large per unit length. Therefore, it is possible to realize a large output from an optical fiber laser which uses a short rare-earth-doped fiber 10, and a small device including such a fiber.

Also, because the rare-earth-doped fiber 10 has a plurality of cores (the center core 11 and the outer cores 12), the mode field diameter (hereinafter called an MFD) is large, and it is possible to avoid an unstable oscillation in the optical fiber laser. Thus, it is possible to realize a stable operation.

The rare-earth-doped fiber 10 has a plurality of outer cores 12, into which rare-earth elements are doped, in addition to a center core 11, which is disposed in a center of the fiber. Therefore, it is possible to utilize a skew mode of the pumping light, and to improve the efficiency of the pumped laser.

Light in a skew mode is reflected entirely in a boarder section between the inner cladding and the outer cladding of the optical fiber. Therefore, the outer cores 12 may be disposed as far as possible from the center of the fiber, such that pumping light having as many modes as possible is transmitted through the outer cores 12.

As shown in FIG. 2, “r” indicates an outer radius of the inner cladding 13. Also, “θ” indicates an angle at which a reflection angle of the pumping light of the skew mode in a boarder between the inner cladding 13 and the outer cladding 14 is projected on a cross section of the rare-earth-doped fiber 10. Such a reflection angle θ may be in a range of 0° to 90°. The skew mode of the reflection angle θ is transmitted through the fiber only outside of a circle 17 which has a radius indicated by “r sin θ”. A half of the skew mode exists in a range which is indicated by “θ≦45°”. Therefore, the outer cores 12 may be disposed outside of a circle which has a radius which is indicated by “r sin 45°=0.71r” so as to utilize more than a half of the skew mode effectively. That is, the outer cores 12 may be disposed such that the distance between the outer cores 12 and the center of the fiber in the inner cladding 13 is greater than 0.71r.

Here, it is not necessary that all of the outer cores 12 be disposed outside of the area which is indicated by 0.71r . It is acceptable as long as at least one of the outer cores 12 is disposed in such an area.

Furthermore, a plurality of cores (the center core 11 and the outer cores 12) are disposed within the common inner cladding 13. Therefore, it is possible to pump light into the plurality of cores by introducing the pumping light from a light source into the rare-earth-doped fiber 10. Therefore, according to the optical fiber laser which uses the rare-earth-doped fiber 10, it is possible to reduce the number of introduction sections for the pumping light, in comparison to a conventional high-output optical fiber laser in which a plurality of rare-earth-doped fibers are used. Therefore, it is possible to manufacture a high-output optical fiber laser at a cheaper cost.

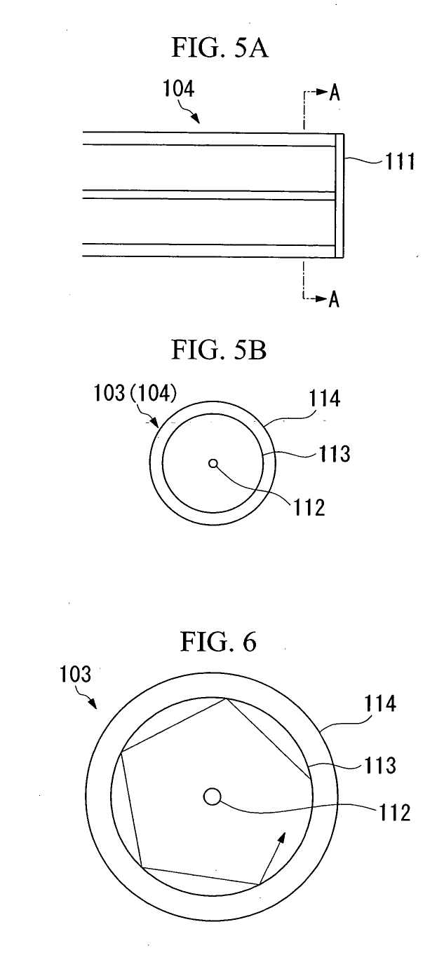

Herein, one example of a rare-earth-doped fiber 10, as shown in FIG. 1, is compared to a conventional rare-earth-doped fiber 103, as shown in FIGS. 5A and 5B. The outer diameters of the above fibers are 125 μm. The diameter of the center core 11 in the rare-earth-doped fiber 10, the diameter of the outer cores 12, and the diameter of the core 112 in the rare-earth-doped fiber 103 are equal. The density of the rare-earth element dopant in the rare-earth-doped fiber 10 and the density of the rare-earth element dopant in the rare-earth-doped fiber 103 are equal. In such a case, the optical fiber laser which uses the rare-earth-doped fiber 10 can emit an output which is seven times as much as the output of the optical fiber laser which uses the rare-earth-doped fiber 103. This is because the rare-earth-doped fiber 10 has seven cores, each of which are the same as the core in the rare-earth-doped fiber 103.

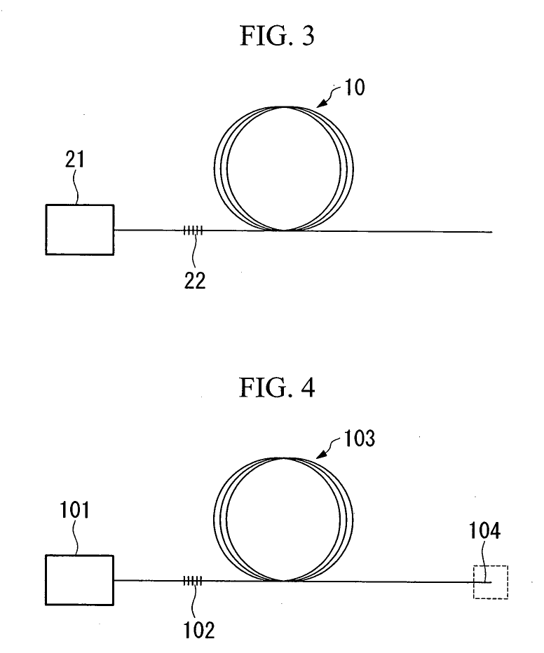

FIG. 3 illustrates an example of an optical fiber laser according to the present invention.

In FIG. 3, reference numeral 21 indicates a pumping laser diode. Reference numeral 22 indicates an optical filter. Reference numeral 10 indicates a rare-earth-doped fiber.

In this optical fiber laser, the optical filter 22, connected to an end surface of the rare-earth-doped fiber 10, is for transmitting a laser light which is emitted from the pumping laser diode 21 and for reflecting the laser light which is emitted from the rare-earth-doped fiber 10. The pumping laser diode 21 for emitting the laser light so as to be incident into the rare-earth-doped fiber 10 is connected to the optical filter 22.

The optical fiber laser of the present embodiment uses the above rare-earth-doped fiber 10. Therefore, there is not an unstable oscillation which may be observed in a multi-mode optical fiber laser. Thus, it is possible to realize a stable operation. Also, it is possible to realize a higher output by the optical fiber laser according to the present embodiment. In addition, it is possible to improve the efficiency for pumping a light.

What is claimed is:

1. A rare-earth-doped fiber, comprising:
a plurality of cores, each made of silica glass doped with a rare earth element;
an inner cladding surrounding all of the plurality of cores and having a refractive index smaller than the refractive index of the plurality of cores;
an outer cladding disposed around the inner cladding and having a refractive index smaller than the refractive index of the inner cladding.

2. The rare-earth-doped fiber according to claim 1, wherein the plurality of cores, each doped with a rare-earth element, are each also doped with germanium or aluminum.

3. The rare-earth-doped fiber according to claim 1, wherein a distance between at least one of the plurality of cores and a central axis of the rare-earth-doped fiber is at least 0.71r , where r is an outer radius of the inner cladding.

4. The rare-earth-doped fiber according to claim 3, wherein the rare earth element is selected from a group consisting of erbium, yttrium, ytterbium, neodymium, holmium, and praseodymium.

5. The rare-earth-doped fiber according to claim 4, wherein each of the plurality of cores is doped with the rare earth element to approximately 1,000 to 40,000 ppm.

6. The rare-earth-doped fiber according to claim 3, wherein the inner cladding is comprised of fluorine-doped silica glass.

7. The rare-earth-doped fiber according to claim 3, wherein the outer cladding is comprised of a fluorine resin.

8. The rare-earth-doped fiber according to claim 3, wherein the diameter of each of the plurality of cores is approximately between 2 and 12 μm.

9. The rare-earth-doped fiber according to claim 3, wherein the outer diameter of the inner cladding is approximately between 100 and 600 μm.

10. The rare-earth-doped fiber according to claim 3, wherein the outer diameter of the outer cladding is approximately between 200 and 800 μm.

11. The rare-earth-doped fiber according to claim 3, wherein the plurality of cores includes a central core disposed along the longitudinal axis of the rare-earth-doped fiber.

12. The rare-earth-doped fiber according to claim 11, wherein the plurality of cores comprises:
the central core, and
six outer cores,
wherein the distance between each of the six outer cores and the central axis of the rare-earth-doped fiber is at least 0.71r.

13. The rare-earth-doped fiber according to claim 12, wherein the six outer cores are equally spaced from one another in a circular pattern around the central axis of the rare-earth-doped fiber.

14. An optical fiber laser, comprising the rare-earth-doped fiber according to any one of claims 1-13.

15. A method of forming a rare-earth-doped fiber, comprising:
providing an inner cladding material;
forming a plurality of through-holes in the inner cladding material parallel to the central axis of the inner cladding material;
inserting a plurality of cores, each made of silica glass doped with a rare earth element, into the through holes in the inner cladding material, the cores having an index of refraction greater than the index of refraction of the inner cladding material;
drawing the inner cladding material, having the plurality of cores inserted therein, until the outer diameter of the inner cladding material reaches a predetermined diameter;
coating the drawn inner cladding material, having the plurality of cores therein, with a resin having a refractive index lower than the refractive index of the inner cladding material.
